(19) United States
(12) Patent Application Publication
(10) Pub. No.: US 2022/0215436 A1
(43) Pub. Date: Jul. 7, 2022

(54) APPARATUSES AND METHODS FOR MANAGING CONTENT IN ACCORDANCE WITH SENTIMENTS

(71) Applicant: Interwise Ltd., Ben-Gurion Airport (IL)

(72) Inventors: Yehuda Volk, Tel-Aviv (IL); Yair Gil, Kfar Saba (IL)

(73) Assignee: Interwise Ltd., Ben-Gurion Airport (IL)

(21) Appl. No.: 17/143,273

(22) Filed: Jan. 7, 2021

(51) Int. Cl. G06Q 30/02; H04N 21/442

(52) U.S. Cl. CPC G06Q 30/0269; G06Q 30/0275; H04N 21/44218; G06Q 30/0277

(57) ABSTRACT

Aspects of the subject disclosure may include, for example, obtaining a first mapping of first target sentiments associated with a first content item, obtaining actual sentiments of a first user during a presentation of the first content item to the first user, comparing the actual sentiments of the first user to the first target sentiments to generate a comparison result, storing the comparison result in a first profile for the first user, and providing the first profile to a creator of the first content item. Other embodiments are disclosed.

### FIELD OF THE DISCLOSURE

The subject disclosure relates to apparatuses and methods for managing content in accordance with sentiments.

### BACKGROUND

As the world becomes increasingly connected through vast communication networks and via various communication devices, new opportunities are generated to target content/content items to users of such networks and devices. In many instances, a content item may be created by a content creator, and the content item may be distributed to a user by a content distributor, such as a network operator or a service provider. The content item may include inventory that may be populated with other content items or creatives, such as advertisements. A sponsor of an advertisement may compensate the creator and/or the distributor of the content item to include the advertisement as part of the inventory. The inclusion of the advertisement as part of the inventory may help to defray/reduce the costs associated with creating and distributing the content item.

Conventionally, a content item (such as a video, for example) is created in advance of a distribution of the content item. The creator of the content item may target a particular emotion/sentiment of/within a user (or pool/community of users) as the user consumes the content item. However, for a variety of reasons (such as for example, characteristics/preferences that are unique to the user), the user's actual emotions/sentiments might not align with, or correspond to, the targeted emotion/sentiment. This lack of alignment/correspondence may reduce/degrade the effectiveness of creatives that may be included as part of inventory within the content item (where the creatives may be selected by a distributor or publisher of the content item). From the perspective of the user, the user's quality of experience (QoE) may suffer as a result of a lack of the alignment/correspondence, which in turn, may motivate/cause the user to cease consuming the content item (and any creatives associated therewith).

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIGS. 2A-2B are block diagrams illustrating example, non-limiting embodiments of systems functioning within the communication network of FIG. 1 in accordance with various aspects described herein.

FIG. 2C depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for provisioning (e.g., creating, distributing, etc.) content items and creatives in accordance with emotions/sentiments. Other embodiments are described in the subject disclosure.

One or more aspects of the subject disclosure include, in whole or in part, generating a mapping of target sentiments with respect to a content item, providing a first portion of the content item to a first user equipment, obtaining first actual sentiments of a first user of the first user equipment during a first presentation of the first portion of the content item by the first user equipment, comparing the first actual sentiments to the target sentiments in accordance with timestamps associated with the first portion of the content item, resulting in a first comparison, determining that the first actual sentiments satisfy first criteria for engaging a first action based on the first comparison, resulting in a first identification of the first action, and engaging the first action based on the first identification of the first action.

One or more aspects of the subject disclosure include, in whole or in part, obtaining a first mapping of first target sentiments associated with a first content item, obtaining a second mapping of second target sentiments associated with a second content item, wherein the second target sentiments are at least partially different from the first target sentiments, providing the first mapping and the second mapping to a communication device to cause the communication device to present the first mapping and the second mapping, obtaining, from the communication device, an indication of a selection of the first content item subsequent to the providing of the first mapping and the second mapping to the communication device, and providing the first content item to the communication device based on the obtaining of the indication of the selection of the first content item.

One or more aspects of the subject disclosure include, in whole or in part, obtaining a first mapping of first target sentiments associated with a first content item, obtaining actual sentiments of a first user during a presentation of the first content item to the first user, comparing the actual sentiments of the first user to the first target sentiments to generate a comparison result, storing the comparison result in a first profile for the first user, and providing the first profile to a creator of the first content item.

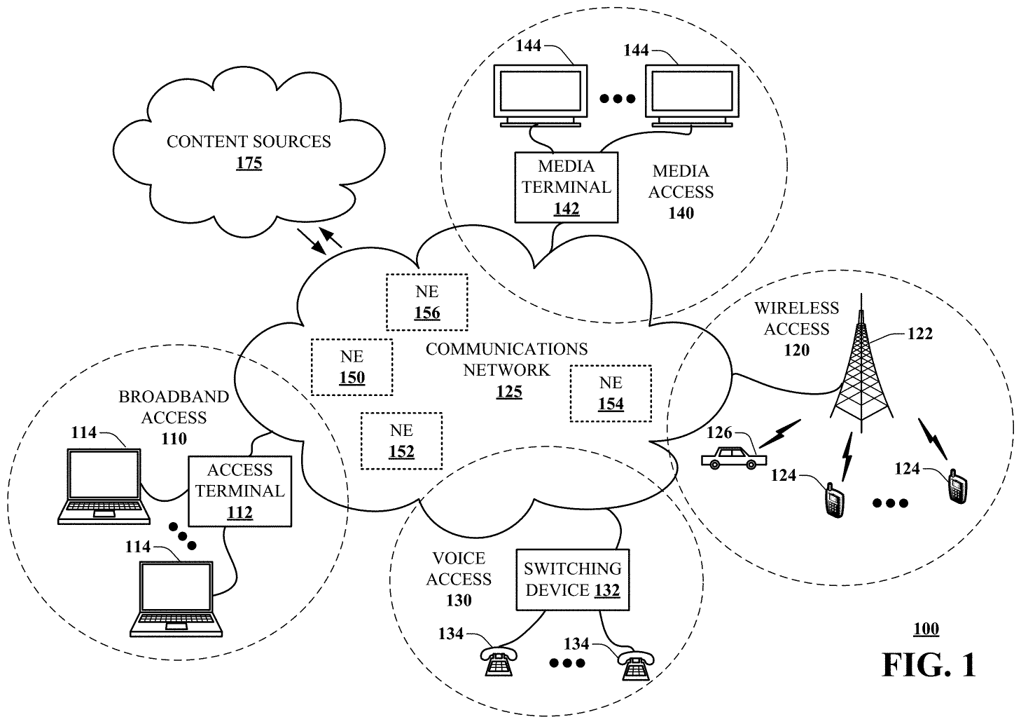

Referring now to FIG. 1, a block diagram is shown illustrating an example, non-limiting embodiment of a communications network 100 in accordance with various aspects described herein. For example, communications network 100 can facilitate in whole or in part generating a mapping of target sentiments with respect to a content item, providing a first portion of the content item to a first user equipment, obtaining first actual sentiments of a first user of the first user equipment during a first presentation of the first portion of the content item by the first user equipment, comparing the first actual sentiments to the target sentiments in accordance with timestamps associated with the first portion of the content item, resulting in a first comparison, determining that the first actual sentiments satisfy first criteria for engaging a first action based on the first comparison, resulting in a first identification of the first action, and engaging the first action based on the first identification of the first action. Communications network 100 can facilitate in whole or in part obtaining a first mapping of first target sentiments associated with a first content item, obtaining a second mapping of second target sentiments associated with a second content item, wherein the second target sentiments are at least partially different from the first target sentiments, providing the first mapping and the second mapping to a communication device to cause the communication device to present the first mapping and the second mapping, obtaining, from the communication device, an indication of a selection of the first content item subsequent to the providing of the first mapping and the second mapping to the communication device, and providing the first content item to the communication device based on the obtaining of the indication of the selection of the first content item. Communications network 100 can facilitate in whole or in part obtaining a first mapping of first target sentiments associated with a first content item, obtaining actual sentiments of a first user during a presentation of the first content item to the first user, comparing the actual sentiments of the first user to the first target sentiments to generate a comparison result, storing the comparison result in a first profile for the first user, and providing the first profile to a creator of the first content item.

In particular, in FIG. 1 a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

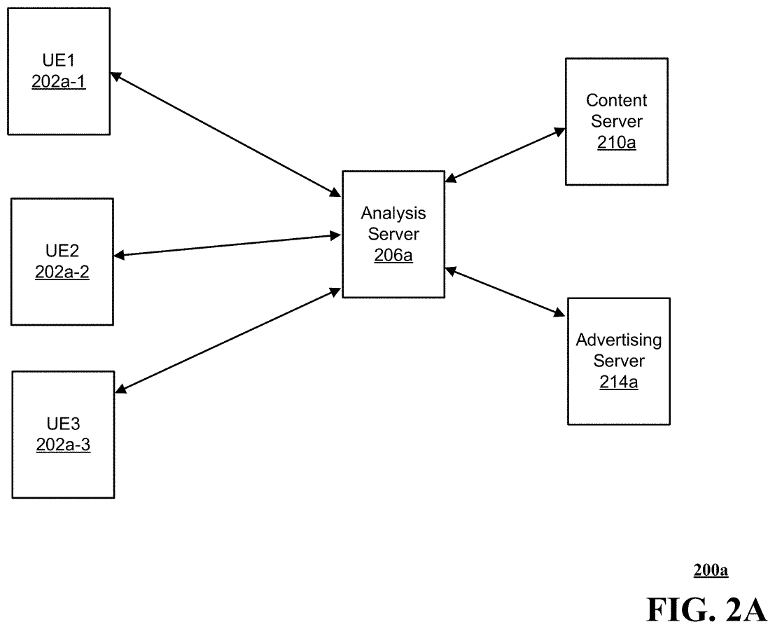

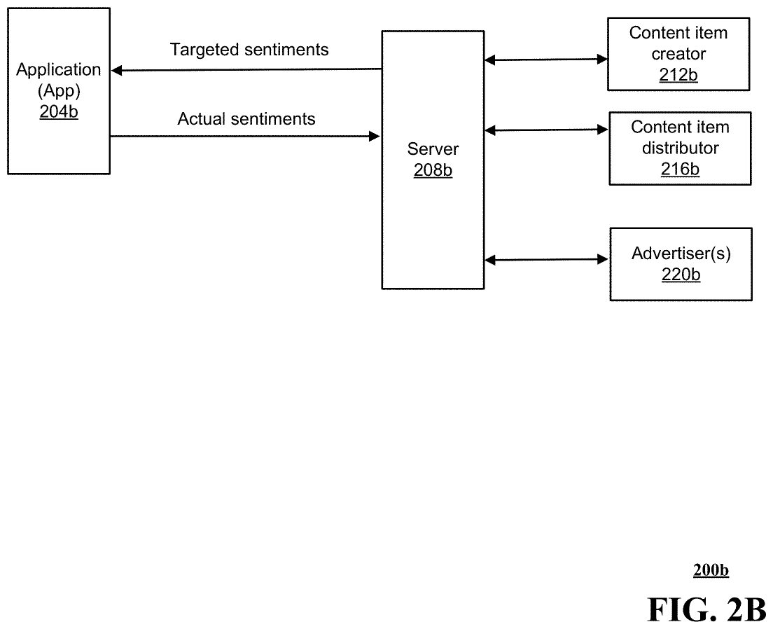

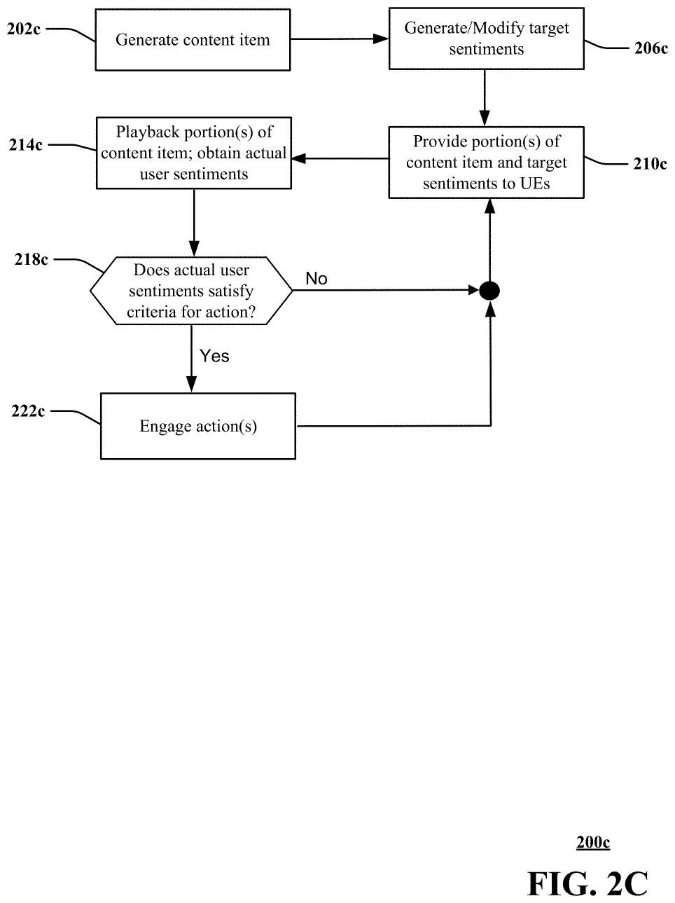

Referring now to FIGS. 2A-2B, block diagrams illustrating example, non-limiting embodiments of systems 200a-200b functioning within, or operatively overlaid upon, the communication network 100 of FIG. 1 in accordance with various aspects described herein are shown. While shown separately, in some embodiments one or more aspects of the system 200a may be combined with one or more aspects of the system 200b.

The system 200a may include one or more communication devices. For example, the system 200a is shown in FIG. 2A as including a first user equipment (UE) 202a-1, a second UE 202a-2, a third UE 202a-3, an analysis server 206a, a content server 210a, and an advertising server 214a. The system 200a may conform to a client-server architecture/arrangement. In some embodiments, the system 200a may incorporate aspects of a peer-to-peer network. While the servers 206a through 214a are shown separately in FIG. 2A, in some embodiments two or more of the servers 206a through 214a may be included/incorporated as part of a common structure (e.g., may be included within a common casing or housing).

A given UE may be associated with one or more users. In some embodiments, the first UE 202a-1 may correspond to a first device of a first user (e.g., a laptop of the first user) and the second UE 202a-2 may correspond to a second device of the first user (e.g., a smartphone of the first user). In some embodiments, user log-in credentials (e.g., username and password, personal identification number, biometric scan information, etc.), information/data contained within a subscriber identification module (SIM) card, etc., may be used to distinguish users of a given device (e.g., the third UE 202a-3).

The UEs 202a-1 through 202a-3 may be communicatively coupled to the server 206a. A given UE (e.g., the first UE 202a-1) may provide data or information to the server 206a that may correspond, or contribute, to a profile of a user that uses the UE. For example, the data or information may include or pertain to: a history of content items (e.g., media, advertisements, etc.) consumed by the given UE (or a user of the UE), characteristics (e.g., audio and/or visual characteristics) that may be used to map a user's reaction to a presentation (e.g., a rendering) of content items, a user's online activities (browsing activities, social media activities, etc.), etc.

Regarding the use of content items, a given UE (or, analogously, a user of the given UE) may request one or more content items. The request may be facilitated by, e.g., a search query, a selection from: an electronic programming guide (EPG), an interactive programming guide (IPG), and/or a menu, etc. The analysis server 206a may receive the request and may identify one or more content items that are to be provided to the UE based on the request. For example, the analysis server 206a may obtain the one or more content items from the content server 210a and may provide (e.g., transmit) the one or more content items to the given UE.

In some embodiments, the analysis server 206a may generate one or more recommendations or suggestions regarding a content item in respect of a given UE (or, analogously, a user of the given UE). For example, if a user of the given UE has a history of consuming comedies, the analysis server may suggest/recommend other comedies for the user. In this regard, a given content item as provided by, e.g., the content server 210a may include metadata that may identify a genre of the content item. Other types of characteristics (e.g., identifications of characters, plot lines/sequences, run time/duration, program name/title, episode/track identifiers, identifications of sponsored content (e.g., advertisement) placement opportunities, etc.) may be included in the metadata that may be used to facilitate recommendations or suggestions for a user in terms of a provisioning or consumption of content items, creatives, etc.

In some embodiments, the metadata associated with a content item may include an identification of one or more emotions or sentiments that are targeted by the creator of the content item and/or a distributor of the content item. For example, assuming that the content item includes a video that is thirty minutes in terms of runtime/duration, the video may include thirty tags/parameters of emotional metadata, each tag corresponding to a respective minute of the overall runtime. Resolutions other than one minute (e.g., a 10-second resolution, a 30-second resolution, a 2-minute resolution, etc.) may be utilized in some embodiments.

In some embodiments, the targeted emotions/sentiments may be provided/presented to a user. To demonstrate, and as shown in FIG. 2B, a server 208b (which may correspond to the server 206a of FIG. 2A in some embodiments) may provide the targeted emotions/sentiments to an application 204b. The application 204b may be executed by one or more communication devices, such as the first UE 202a-1 of FIG. 2A. The targeted emotions/sentiments may be included as part of a file that may, for the sake of convenience, be referred to herein as a targeted emotions file.

Continuing the above example, the targeted emotions/sentiments as provided by the server 208b may be presented via the application 204b as, e.g., a map, a graph, an image, an audio guide, and/or any other indications/indicators that convey the intended emotional/sentimental targets over the entirety of the thirty minute runtime video in one-minute increments. In this regard, if the user is interested in, e.g., the portions of the video that are intended/targeted to be comedic/funny/humorous in nature, the user may have an ability to select (e.g., fast-forward to) those portions, potentially skipping/avoiding other portions of the video associated with other intended/targeted emotions/sentiments (e.g., sadness, anger, etc.). In this manner, the user may have an ability/capability to generate/create a customized/tailored playback experience of the video in terms of the targeted emotions/sentiments.

In some embodiments, the indicator/indications of the targeted emotions/sentiments may be utilized by a user to select the video relative to another content item. For example, if the user is in need of a pick-me-up or laugh after a tough day of work, the user may prefer the video relative to listening to a compilation of musical tracks that are ‘dark’ or melancholy in tone or nature. Based on observing the targeted emotions/sentiments associated with the video and the targeted emotions/sentiments associated with the compilation of musical tracks, the user may opt for the video in this example.

In some embodiments, a user's actual emotions/sentiments as expressed during a presentation of one or more portions of a content item (e.g., a video) may be monitored. The monitoring may include requesting the user to provide feedback in response to a query/survey, such as for example “Did you believe the scene/segment just presented in this video was funny?”. The user may have an ability to answer or respond to the query in one or more forms, such as for example a selection of a thumb's up icon (or the like) to confirm that the presented scene/segment was funny or a selection of a thumb's down icon (or the like) to indicate that the presented scene/segment was not funny. In some embodiments, a presentation of the content item may be paused until the user provides a response to the query to ensure that: (1) the user does not miss other (e.g., subsequent) scenes/segments of the video, and/or (2) the user actually provides a response.

In some embodiments, the user's responses may be inferred based on the use of passive techniques. For example, in some embodiments facial recognition technologies may be utilized, whereby a camera may monitor a user's face for expressions. The facial expressions as captured by the camera may be compared with a record/log of expressions (particular to the user, or relative to a pool/community of users) to identify/determine a likely emotion/sentiment that the user was feeling during the scene/segment. In some embodiments, audio equipment (e.g., a microphone) may be utilized to gauge the user's emotions/sentiments during the scene/segment. For example, audio outputs (e.g., laughter, speech, cries/shrieks, etc.) provided by the user may be monitored by the audio equipment and compared with a record/log of audio outputs (particular to the user, or relative to a pool/community of users) to identify/determine a likely emotion/sentiment that the user was feeling. Other types of (passive) monitors, such as for example heart rate monitors, pulse rate monitors, cortisol monitors, pupil or retinal monitors, etc., may be utilized to identify/determine a user's likely emotions/sentiments.

In some embodiments, machine learning (ML) and/or artificial intelligence (AI) technologies/algorithms, or the like, may be utilized to reduce any error in the prediction of the user's emotions/sentiments. Stated slightly differently, any error that may be present may be provided as feedback to the technologies/algorithms, such that the error may tend to converge towards zero the more the technologies/algorithms are utilized/exercised.

In some embodiments, outputs of the various monitors/monitoring activities may be combined to identify/determine a user's (likely) emotions/sentiments towards various portions of a content item. For example, one or more filtering or averaging techniques/algorithms may be utilized to identify/determine the user's (probable) emotions/sentiments from the outputs.

The user's emotions/sentiments, as obtained via the monitors/monitoring activities, may be tracked to the respective portions of the content item. For example, the user's emotions/sentiments may be associated with a timestamp in a playback/presentation of the content item. The pairing of the user's emotions/sentiments with the timestamps may be included as data in one or more files, referred to below as an actual sentiments file(s). As represented in FIG. 2B, the actual sentiments may be provided by, e.g., the application 204b (or a communication device, such as a UE, associated with the application 204b) to the server 208b.

The actual sentiments file(s) associated with a given user (or a pool/community of users) may be provided to one or more parties or entities, such as for example a creator of a content item 212b associated with the actual sentiments file(s), a distributor/publisher of the content item 216b, one or more advertisers 220b, etc. The different parties/entities (or associated communication devices) may process the data of the actual sentiments file(s) in one or more ways. For example, the creator 212b may compare the targeted/intended emotions/sentiments associated with the various portions (e.g., segments/scenes) of the content item to the actual emotions/sentiments. If the two are similar (e.g., if the two are within a threshold of one another), that may serve as confirmation that the creator 212b achieved/obtained a targeted emotional state in the user (or pool/community of users), and may encourage the creator 212b to create/generate additional content items that have a similar emotional/sentimental target. On the other hand, if the two are different from one another in an amount greater than the threshold, the creator 212b may use that information as part of planning/generating additional content items (such as, for example, future episodes in a television series).

In this regard, emotions/sentiments may be quantified to facilitate the comparisons between targeted emotions/sentiments and actual emotions/sentiments described above. For example, in some embodiments whether a user is ‘sad’ may be scored on a scale of 1 to 100, where a score of 1 may be indicative of the user is not being very sad, and a score of 100 may be indicative of the user being very sad. Of course, other values/ranges of scores may be used in some embodiments (e.g., such as a 4-star rating/scale).

The distributor/publisher 216b may use the data of the actual sentiments file(s) to determine whether it is worth continuing to distribute the content item (or other content items produced by the creator 212b), to identify terms/conditions for distributing the content item (e.g., to identify a price that is charged to the creator 212b for distribution of the content item), to identify other content items that elicit/provoke similar emotional responses in users (and potentially bundle the content item with the other content items as part of a package or other service offering), etc.

The advertiser(s) 220b may use the data of the actual sentiments file(s) to determine whether placement of one or more advertisements of the advertiser(s) 220b in inventory that may be present in the content item is warranted/desired, and if so, a price that the advertiser(s) 220b is/are willing to pay for the inclusion of the advertisement(s) in the inventory. As one skilled in the art would appreciate, a price that an advertiser 220b is willing to pay may take the form of a bid in conjunction with one or more bidding models, auctions (e.g., real-time auctions), or the like, that may be facilitated by, e.g., the analysis server 206a of FIG. 2A, the advertising server 214a of FIG. 2A, the server 208b of FIG. 2B, or any combination thereof. Advertisements associated with one or more winning bids from bids that are solicited from one or more sponsors/advertisers may be selected for populating the inventory.

In some embodiments, an advertiser 220b may provide criteria, such as line items, that identify target sentiments that the advertiser 220b wants to achieve/realize. In such embodiments, when a user (or pool/community of users) actually achieves/obtains such a sentiment, an advertisement of the advertiser 220b may be selected for inclusion in one or more bids, auctions, etc. In this manner, at least a portion of the process of including/incorporating an advertisement in inventory may be automated on behalf of the advertiser 220b.

Referring now to FIG. 2C, an illustrative embodiment of a method 200c in accordance with various aspects described herein is shown. The method 200c may be executed, in whole or in part, by one or more systems, devices, and/or components, such as for example the systems, devices, and components set forth herein. The method 200c may be executed to, e.g., identify the degree or extent that a targeted emotion/sentiment present within a content item matches an actual emotion/sentiment expressed/experienced by one or more users.

In block 202c, a content item may be generated. For example, as part of block 202c a content item creator may create the content item. The content item may be offered to a publisher/disseminator/distributor for, e.g., distribution purposes as part of block 202c.

In block 206c, target sentiments associated with the content item may be generated in a first instance or modified in subsequent instances. For example, as part of block 206c the content item creator may assign intended/targeted user emotional states to one or more portions of the content item. In some embodiments, block 206c may include a publisher/disseminator/distributor applying intended/targeted user emotional states to one or more portions of the content item. The target sentiments of block 206c may be included in metadata, may be included as part of one or more files, etc.

In block 210c, one or more portions of the content item of block 202c and/or target sentiments of block 206c that are associated with the one or more portions of the content item may be provided (e.g., transmitted) to one or more communication devices (e.g., one or more UEs). In some embodiments, in conjunction with a first execution of block 210c in respect of a content item, the portions of the content item may include an initial portion (e.g., the first five minutes) associated with a playback or presentation of the content item. In subsequent instances of the execution of block 210c in respect of the content item, the portions of the content item may correspond to portions that are different from (e.g., portions that are subsequent to) the initial portion in the playback/presentation.

In some embodiments, as part of block 210c the portion(s) of the content item may be provided to the UEs in respect of one or more user selections of the content item (or the portions thereof). For example, based on a provisioning of the target sentiments to the UEs as part of block 210c, a user of a UE may select the content item (or the portions thereof) in accordance with the target sentiments matching the user's interests at that time. In some embodiments, the selections may be facilitated by a user profile, such that the user might not be required to provide an affirmative selection.

In block 214c, a UE may present or playback the portions of the content item that the UE obtained (e.g., received) as part of block 210c. As part of block 214c, actual user sentiments may be obtained (potentially in accordance with one or more of the monitors/monitoring techniques described above) during the presentation/playback of the portions of the content item.

In block 218c, a determination may be made whether the actual user sentiments of block 214c satisfy criteria for engaging one or more actions. If so, flow may proceed from block 218c to block 222c. Otherwise, flow may proceed from block 218c to block 210c. As part of the flow from block 218c to block 210c, other (e.g., subsequent) portions of the content item (and/or any associated target sentiments) may be provided to the UEs.

As part of block 218c, and in the context of presenting an advertisement (as part of block 222c as described below), it may be an objective of the creator of the content item and/or a distributor of the content item to build suspense in a given user to motivate the user to: stay for the duration of a commercial/advertising break in the content item, avoid changing the content item that is being presented, etc. In this regard, the criteria of block 218c may include identifying when the user's intrigue/excitement/suspense in the content item being presented is greater than a threshold to warrant a presentation of an advertisement.

In some embodiments, the criteria of block 218c may include identifying when the user's actual sentiments of block 214c match the target sentiments of block 206c in an amount that is within a threshold. In the event of such a match, a presentation of an advertisement (as part of block 222c) may be warranted.

In some embodiments, the criteria of block 218c may include identifying when the user's actual sentiments of block 214c are mismatched relative to the target sentiments of block 206c in an amount that is greater than a threshold. In the event of such a mismatch, an action (of block 222c described below) may be warranted to modify a plotline or sequence from a baseline plotline/sequence in an effort to cause the user's sentiments/emotions to more closely mesh/align with the target sentiments.

In block 222c one or more actions may be taken/engaged. For example, and as described above, as part of block 222c one or more advertisements may be selected and provided to the UEs for presentation. As part of block 222c, a first advertisement that is provided to a first UE or first user may be different from a second advertisement that is provided to a second UE or second user. Still further, assuming that the same content item is being referenced and that a playback associated therewith started at the same time at the first and second UEs, the first advertisement may be presented at a first point in time in the playback at the first UE and the second advertisement may be presented at a second point in time in the playback at the second UE, where the second point in time may be different from the first point in time. In this regard, the traditional notion of a static or predetermined “commercial break” frequently found in many content items may be inapplicable in some embodiments of this disclosure. Stated differently, a commercial break or timeslot in accordance with aspects of this disclosure may be dynamic in nature and may be selected to coincide with a given user's actual sentiments/emotions.

As described above, block 222c may include modifying a plotline or sequence in an effort to cause a user's sentiments/emotions to more closely align/mesh with the target sentiments. In this regard, if the initial portions of a content item are targeted to elicit/provoke feelings of excitement in users, and a particular user's emotions/sentiments suggest/indicate that the particular user is bored or disinterested, the particular user may be provided with additional (e.g., subsequent) portions of the content item (as part of the flow from block 222c to block 210c in FIG. 2C) that are intended to evoke even greater excitement in users. Conversely, if the particular user's emotions/sentiments suggest/indicate that the particular user is extremely excited/nervous when consuming the initial portions of the content item, the particular user may be provided with additional portions of the content item (as part of the flow from block 222c to block 210c) that are intended to pacify or calm users. In this regard, two users that happen to select a given content item may obtain different versions of the content item based on each of the respective user's actual emotions/sentiments. In this manner, a customized/tailored experience that is particular/unique to a given user may be obtained.

While for purposes of simplicity of explanation, the respective processes are shown and described as a series of blocks in FIG. 2C, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

In some embodiments, a user's actual emotions/sentiments, as potentially incorporated in one or more profiles, may be anonymized prior to being shared with one or more parties or entities. In this manner, accuracy or alignment of the user's emotions/sentiments may be obtained in respect of one or more targets or actions, while at the same time providing the user with a degree of security and privacy.

As described herein, in some embodiments one or more thresholds may be utilized in terms of determining/identifying one or more actions to be taken or engaged. The thresholds may be adaptive in nature in response to an occurrence of one or more events or conditions (or, analogously, an absence of an occurrence of one or more events or conditions). In some embodiments, a threshold may be based on an identity of a user, an identity of a communication device, or a combination thereof, which is to say that a one-size-fits-all approach might not be utilized in some embodiments.

As described above, aspects of the disclosure may be utilized to determine/identify when a user is adequately prepared to be presented with a creative (e.g., an advertisement). For example, adequate preparation may entail that a user's emotions/sentiments are aligned with a targeted emotional/sentimental state associated with the creative. In this regard, a timeslot for presenting a creative within a runtime/duration of a presentation of a content item may be adapted to conform to emotions/sentiments experienced by one or more users.

As set forth above, portions of a content item may be provided to a plurality of users (or communication devices associated with the users). Different versions of a presentation of the content item may be realized as between a first user of the plurality of users and one or more other users of the plurality of users based on emotions/sentiments expressed by each of the users. For example, different portions may be provided to the first user and a second user included in the plurality of users. Those different portions may be presented in the same corresponding timeslot within the overall runtime/duration of the content item.

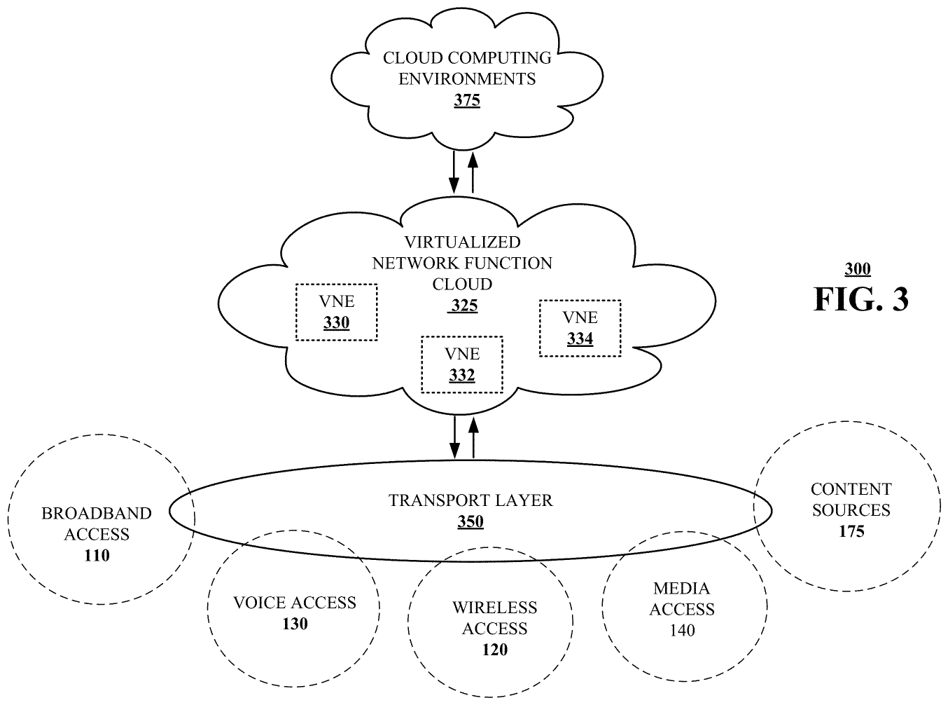

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of communication network 100 and the subsystems and functions of systems 200a-200b and method 200c presented in FIGS. 1, 2A, 2B, and 2C. For example, virtualized communication network 300 can facilitate in whole or in part generating a mapping of target sentiments with respect to a content item, providing a first portion of the content item to a first user equipment, obtaining first actual sentiments of a first user of the first user equipment during a first presentation of the first portion of the content item by the first user equipment, comparing the first actual sentiments to the target sentiments in accordance with timestamps associated with the first portion of the content item, resulting in a first comparison, determining that the first actual sentiments satisfy first criteria for engaging a first action based on the first comparison, resulting in a first identification of the first action, and engaging the first action based on the first identification of the first action. Virtualized communication network 300 can facilitate in whole or in part obtaining a first mapping of first target sentiments associated with a first content item, obtaining a second mapping of second target sentiments associated with a second content item, wherein the second target sentiments are at least partially different from the first target sentiments, providing the first mapping and the second mapping to a communication device to cause the communication device to present the first mapping and the second mapping, obtaining, from the communication device, an indication of a selection of the first content item subsequent to the providing of the first mapping and the second mapping to the communication device, and providing the first content item to the communication device based on the obtaining of the indication of the selection of the first content item. Virtualized communication network 300 can facilitate in whole or in part obtaining a first mapping of first target sentiments associated with a first content item, obtaining actual sentiments of a first user during a presentation of the first content item to the first user, comparing the actual sentiments of the first user to the first target sentiments to generate a comparison result, storing the comparison result in a first profile for the first user, and providing the first profile to a creator of the first content item.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

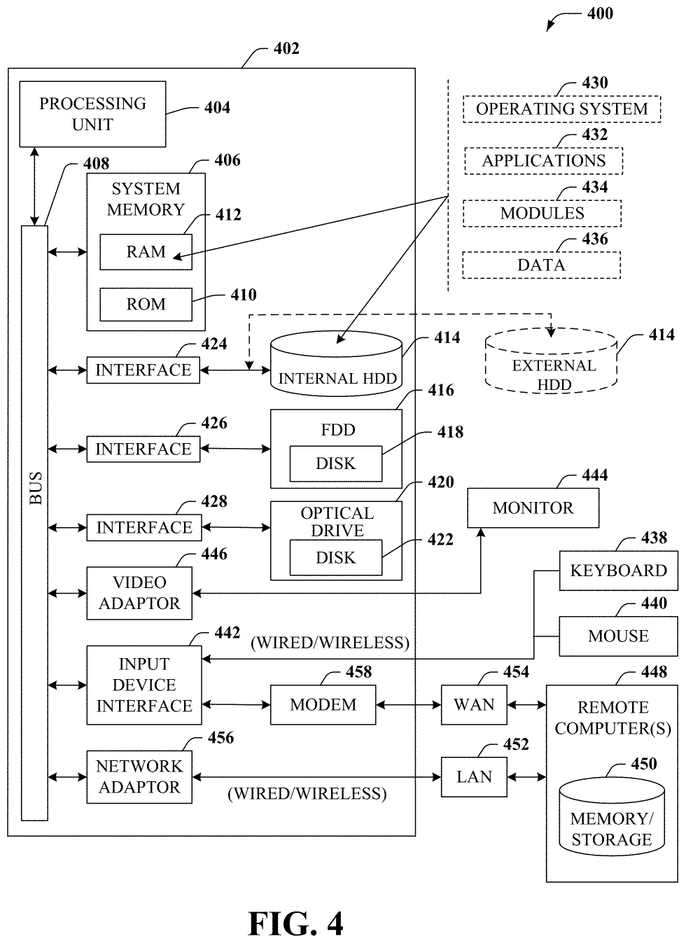

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part generating a mapping of target sentiments with respect to a content item, providing a first portion of the content item to a first user equipment, obtaining first actual sentiments of a first user of the first user equipment during a first presentation of the first portion of the content item by the first user equipment, comparing the first actual sentiments to the target sentiments in accordance with timestamps associated with the first portion of the content item, resulting in a first comparison, determining that the first actual sentiments satisfy first criteria for engaging a first action based on the first comparison, resulting in a first identification of the first action, and engaging the first action based on the first identification of the first action. Computing environment 400 can facilitate in whole or in part obtaining a first mapping of first target sentiments associated with a first content item, obtaining a second mapping of second target sentiments associated with a second content item, wherein the second target sentiments are at least partially different from the first target sentiments, providing the first mapping and the second mapping to a communication device to cause the communication device to present the first mapping and the second mapping, obtaining, from the communication device, an indication of a selection of the first content item subsequent to the providing of the first mapping and the second mapping to the communication device, and providing the first content item to the communication device based on the obtaining of the indication of the selection of the first content item. Computing environment 400 can facilitate in whole or in part obtaining a first mapping of first target sentiments associated with a first content item, obtaining actual sentiments of a first user during a presentation of the first content item to the first user, comparing the actual sentiments of the first user to the first target sentiments to generate a comparison result, storing the comparison result in a first profile for the first user, and providing the first profile to a creator of the first content item.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

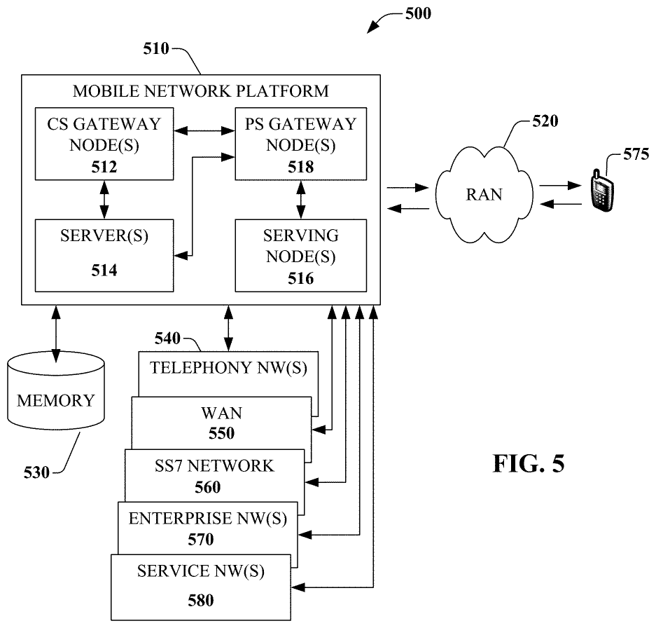

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part generating a mapping of target sentiments with respect to a content item, providing a first portion of the content item to a first user equipment, obtaining first actual sentiments of a first user of the first user equipment during a first presentation of the first portion of the content item by the first user equipment, comparing the first actual sentiments to the target sentiments in accordance with timestamps associated with the first portion of the content item, resulting in a first comparison, determining that the first actual sentiments satisfy first criteria for engaging a first action based on the first comparison, resulting in a first identification of the first action, and engaging the first action based on the first identification of the first action. Platform 510 can facilitate in whole or in part obtaining a first mapping of first target sentiments associated with a first content item, obtaining a second mapping of second target sentiments associated with a second content item, wherein the second target sentiments are at least partially different from the first target sentiments, providing the first mapping and the second mapping to a communication device to cause the communication device to present the first mapping and the second mapping, obtaining, from the communication device, an indication of a selection of the first content item subsequent to the providing of the first mapping and the second mapping to the communication device, and providing the first content item to the communication device based on the obtaining of the indication of the selection of the first content item. Platform 510 can facilitate in whole or in part obtaining a first mapping of first target sentiments associated with a first content item, obtaining actual sentiments of a first user during a presentation of the first content item to the first user, comparing the actual sentiments of the first user to the first target sentiments to generate a comparison result, storing the comparison result in a first profile for the first user, and providing the first profile to a creator of the first content item.

In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It is should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

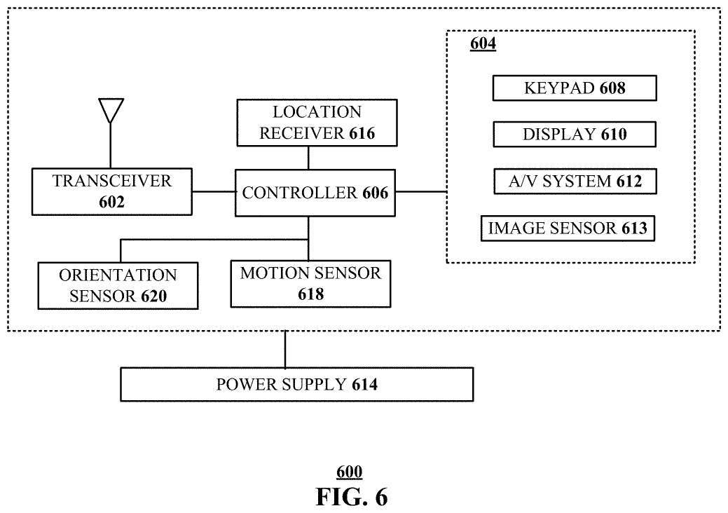

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part generating a mapping of target sentiments with respect to a content item, providing a first portion of the content item to a first user equipment, obtaining first actual sentiments of a first user of the first user equipment during a first presentation of the first portion of the content item by the first user equipment, comparing the first actual sentiments to the target sentiments in accordance with timestamps associated with the first portion of the content item, resulting in a first comparison, determining that the first actual sentiments satisfy first criteria for engaging a first action based on the first comparison, resulting in a first identification of the first action, and engaging the first action based on the first identification of the first action. Computing device 600 can facilitate in whole or in part obtaining a first mapping of first target sentiments associated with a first content item, obtaining a second mapping of second target sentiments associated with a second content item, wherein the second target sentiments are at least partially different from the first target sentiments, providing the first mapping and the second mapping to a communication device to cause the communication device to present the first mapping and the second mapping, obtaining, from the communication device, an indication of a selection of the first content item subsequent to the providing of the first mapping and the second mapping to the communication device, and providing the first content item to the communication device based on the obtaining of the indication of the selection of the first content item. Computing device 600 can facilitate in whole or in part obtaining a first mapping of first target sentiments associated with a first content item, obtaining actual sentiments of a first user during a presentation of the first content item to the first user, comparing the actual sentiments of the first user to the first target sentiments to generate a comparison result, storing the comparison result in a first profile for the first user, and providing the first profile to a creator of the first content item.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth® ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAIVI). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

1. A device, comprising:
a processing system including a processor; and
a memory that stores executable instructions that, when executed by the processing system, facilitate performance of operations, the operations comprising:
generating a mapping of target sentiments with respect to a content item;
providing a first portion of the content item to a first user equipment;
obtaining first actual sentiments of a first user of the first user equipment during a first presentation of the first portion of the content item by the first user equipment;
comparing the first actual sentiments to the target sentiments in accordance with timestamps associated with the first portion of the content item, resulting in a first comparison;
determining that the first actual sentiments satisfy first criteria for engaging a first action based on the first comparison, resulting in a first identification of the first action; and
engaging the first action based on the first identification of the first action.

2. The device of claim 1, wherein the operations further comprise:
providing the mapping of the target sentiments to the first user equipment.

3. The device of claim 2, wherein the operations further comprise:
subsequent to the providing of the mapping of the target sentiments to the first user equipment, obtaining a first indication of a first selection of the content item from the first user equipment,
wherein the providing of the first portion of the content item to the first user equipment is responsive to the obtaining of the first indication of the first selection of the content item from the first user equipment.

4. The device of claim 1, wherein the determining that the first actual sentiments satisfy the first criteria for engaging the first action based on the first comparison includes determining that the first actual sentiments are within a threshold of the target sentiments.

5. The device of claim 1, wherein the first identification of the first action includes an identification of a first timeslot for the first user equipment to present a first creative.

6. The device of claim 5, wherein the first creative includes a first advertisement.

7. The device of claim 6, wherein the operations further comprise:
selecting the first advertisement based on the first actual sentiments of the first user, resulting in a first selection,
wherein the engaging of the first action includes providing the first advertisement to the first user equipment based on the first selection.

8. The device of claim 7, wherein the operations further comprise:
providing the first portion of the content item to a second user equipment;
obtaining second actual sentiments of a second user of the second user equipment during a second presentation of the first portion of the content item by the second user equipment, wherein the second actual sentiments are at least partially different from the first actual sentiments;
comparing the second actual sentiments to the target sentiments in accordance with the timestamps, resulting in a second comparison;
determining that the second actual sentiments satisfy second criteria for engaging a second action based on the second comparison, resulting in a second identification of the second action, wherein the second action is different from the first action; and
engaging the second action based on the second identification of the second action.

9. The device of claim 8, wherein the second identification of the second action includes an identification of a second timeslot for the second user equipment to present a second advertisement, and wherein the second timeslot is different from the first timeslot.

10. The device of claim 8, wherein the determining that the first actual sentiments satisfy the first criteria for engaging the first action based on the first comparison includes determining that the first actual sentiments differ from the target sentiments in a first amount that is greater than a first threshold.

11. The device of claim 10, wherein the operations further comprise:
selecting a second portion of the content item based on the determining that the first actual sentiments differ from the target sentiments in the first amount that is greater than the first threshold; and
providing the second portion of the content item to the first user equipment to facilitate a third presentation of the second portion of the content item by the first user equipment subsequent to the first presentation of the first portion of the content item by the first user equipment.

12. The device of claim 11, wherein the determining that the second actual sentiments satisfy the second criteria for engaging the second action based on the second comparison includes determining that the second actual sentiments differ from the target sentiments in a second amount that is greater than the first threshold, and wherein the operations further comprise:
selecting a third portion of the content item based on the determining that the second actual sentiments differ from the target sentiments in the second amount that is greater than the first threshold, wherein the third portion of the content item is different from the second portion of the content item; and
providing the third portion of the content item to the second user equipment to facilitate a fourth presentation of the third portion of the content item by the second user equipment subsequent to the second presentation of the first portion of the content item by the second user equipment.

13. The device of claim 1, wherein the content item includes a video, a musical track, or a combination thereof.

14-20. (canceled)

21. A non-transitory machine-readable medium, comprising executable instructions that, when executed by a processing system including a processor, facilitate performance of operations, the operations comprising:
obtaining first actual sentiments of a first user during a first presentation of a content item;
comparing the first actual sentiments to target sentiments in accordance with timestamps associated with the content item, resulting in a first comparison;
determining that the first actual sentiments satisfy first criteria for engaging a first action based on the first comparison, resulting in a first identification of the first action; and
engaging the first action based on the first identification of the first action.

22. The non-transitory machine-readable medium of claim 21, wherein the operations further comprise:
monitoring for the first actual sentiments of the first user during the first presentation of the content item by a communication device, wherein the obtaining of the first actual sentiments of the first user is based on the monitoring.

23. The non-transitory machine-readable medium of claim 21, wherein the determining that the first actual sentiments satisfy the first criteria comprises determining that the first actual sentiments exceed a threshold, and wherein the operations further comprise:
responsive to the determining that the first actual sentiments exceed the threshold, causing the first presentation of the content item by a communication device to be paused and causing a first advertisement to be presented by the communication device in a first advertising timeslot; and
causing the first presentation of the content item by the communication device to resume subsequent to the first advertising timeslot.

24. The non-transitory machine-readable medium of claim 23, wherein the operations further comprise:
selecting the first advertisement based on the first actual sentiments; and
providing the first advertisement to the communication device in accordance with the selecting of the first advertisement.

25. The non-transitory machine-readable medium of claim 24, wherein the operations further comprise:
soliciting a first bid from a first sponsor of the first advertisement and a second bid from a second sponsor of a second advertisement,
wherein the selecting of the first advertisement is further based on the first bid and the second bid.

26. A method, comprising:
providing, by a processing system including a processor, a first portion of a content item to a first user equipment;
obtaining, by the processing system, first actual sentiments of a first user of the first user equipment during a first presentation of the first portion of the content item by the first user equipment;
determining, by the processing system, that the first actual sentiments satisfy first criteria for engaging a first action based on a comparison of the first actual sentiments to target sentiments, resulting in a first identification of the first action; and
engaging, by the processing system, the first action based on the first identification of the first action.

27. The method of claim 26, wherein the obtaining of the first actual sentiments includes providing a query to the first user and receiving an answer from the first user in response to the query.
